(19) United States
(12) Patent Application Publication
(10) Pub. No.: US 2019/0101191 A1
(43) Pub. Date: Apr. 4, 2019

(54) AGRICULTURAL MACHINE TRANSMISSION, IN PARTICULAR FOR AN AGRICULTURAL MACHINE OF AN AGRICULTURAL OR COMMUNAL UTILITY VEHICLE

(71) Applicant: ZF Friedrichshafen AG, Friedrichshafen (DE)

(72) Inventors: Michael HAAS, Hengersberg (DE); Martin DANKESREITER, Tiefenbach (DE); Simon STERL, Thyrnau (DE)

(21) Appl. No.: 16/112,987

(22) Filed: Aug. 27, 2018

(30) Foreign Application Priority Data
Sep. 29, 2017 (DE) 10 2017 217 388.2

(51) Int. Cl. F16H 3/091; F16H 3/52; F16H 61/04; F16H 37/04

(52) U.S. Cl. CPC F16H 3/0915; F16H 3/52; F16H 2003/0803; F16H 37/042; F16H 37/041; F16H 61/0403

(57) ABSTRACT

An agricultural machine transmission, in particular for an agricultural machine group transmission of an agricultural or a communal utility vehicle, having exactly one input shaft (8) and exactly one output shaft (11) as well as a plurality of shifting elements (25, 26, 27, 28). Various transmission ratios can be engaged, between the input shaft (8) and the output shaft (11), by the selective actuation of plurality of shifting elements (25, 26, 27, 28). To achieve a compact structure and low manufacturing costs, the input shaft (8) and the output shaft (11) are coaxial with one another and, by actuating one of the plurality of shifting elements (28), can be connected directly to one another in a rotationally fixed manner.

This application claims priority from German patent application serial no. 10 2017 217 388.2 filed Sep. 29, 2017.

### FIELD OF THE INVENTION

The invention relates to an agricultural machine transmission, in particular for an agricultural machine group transmission of an agricultural or municipal utility vehicle, comprising exactly one input shaft and exactly one output shaft and a plurality of shifting elements, by the selective actuation of which various transmission ratios between the input shaft and the output shaft can be engaged. In addition the invention relates to an agricultural machine group transmission having an agricultural machine transmission as above.

### BACKGROUND OF THE INVENTION

In agricultural and also in municipal utility vehicles, due to the wide range of jobs they have to perform, various driving ranges have to be engaged, which in a transmission of such a utility vehicle makes it necessary to have a large spread between a slowest and a fastest gear. Moreover, in an agricultural machine transmission there must be no stepped intervals between the individual gear steps, so that in combination with the large spread a large number of gears are required. To be able to realize this large number of gears at reasonable cost, transmissions of agricultural or municipal utility vehicles are often designed as group transmissions.

In most cases an agricultural machine group transmission of this type consists of a multi-step or main group, an upstream or downstream splitter group, a usually downstream range group and often also a reversing group and a crawling gear group. The gear sequence of the agricultural machine group transmission is determined by the main group, and this can be correspondingly influenced by the upstream and/or downstream further transmission groups depending on the gear ratios engaged therein. Often, however, a main and a splitter group are combined to form a powershiftable transmission group, which then in most cases has a non-powershiftable range group connected downstream from it.

DE 10 2011 077 597 A1 describes an agricultural machine group transmission which consists of a powershiftable splitter or main group, an intermediate group and a downstream range group. In this case the range group is in the form of a non-powershiftable agricultural machine transmission and comprises exactly one input shaft and exactly one output shaft running parallel to the input shaft, with a plurality of spur gear stages provided between the input shaft and the output shaft. Each spur gear stage consists of a loose gear and a fixed gear, of which one is positioned on the input shaft and one on the output shaft. In addition an interlocking shifting element is associated with each of the spur gear stages, which when actuated connects the respective loose gear rotationally fixed to the input or output shaft and correspondingly engages an associated gear between the input shaft and the output shaft.

### SUMMARY OF THE INVENTION

Starting from the prior art described above, it is now the purpose of the present invention to provide an agricultural machine transmission particularly well suited for use in an agricultural machine group transmission, which is characterized by a compact structure and low production costs.

Starting from the independent claims this objective is achieved in combination with their characterizing features. The subsequent, dependent claims in each case describe advantageous further developments of the invention. Further, an agricultural machine group transmission in which an agricultural machine transmission according to the invention is used is the object of the claims.

According to the invention, the agricultural machine transmission has exactly one input shaft and exactly one output shaft, along with a plurality of shifting elements by the selective actuation of which various transmission ratios between the input shaft and the output shaft can be engaged. Since in the agricultural machine transmission according to the invention just one input shaft and just one output shaft are provided, when a power flow occurs in the agricultural machine transmission this power flow always passes by way of one and the same input shaft and one and the same output shaft. Thus, the agricultural machine transmission according to the invention is explicitly not a dual-clutch transmission with more than one input shaft.

In the context of the invention an “agricultural machine transmission” is a transmission specially provided for use in an agricultural or in a municipal utility vehicle. In this case an agricultural or municipal utility vehicle is preferably a farm tractor, a system vehicle such as an equipment carrier, or even a self-driving harvester. Explicitly excluded from this is the different category of utility vehicles that includes trucks in particular.

The invention, now, is based on the technical principle that the input shaft and the output shaft are coaxial with one another and can be connected to one another in a rotationally fixed manner by actuating a shifting element. In other words, the exactly one input shaft and the exactly one output shaft are arranged coaxially with one another and in the closed condition of a shifting element the input shaft and the output shaft are connected rotationally fixed with one another so that a fixed drive path from the input to the output shaft is produced.

Such a design of an agricultural machine transmission has the advantage that due to the direct, rotationally fixed connection of the input and output shafts a direct drive path and thus a transmission ratio of the agricultural machine transmission can be produced, without having to pass the power flow via a gearwheel stage. Consequently, an otherwise necessary gearwheel stage can be omitted, which on the one hand reduces the space occupied by the transmission and on the other hand also reduces its production costs. Moreover, the coaxial arrangement of the input and output shafts has the further advantage that it makes possible a coaxial arrangement of the drive input and the drive output of the agricultural machine transmission.

In contrast to this, the input shaft and the output shaft of the transmission described in DE 10 2011 077 597 A1 are axially offset from one another, so that even to obtain a direct gear a corresponding spur gear stage is required. Thus, this increases the installation space needed and the production costs.

Particularly preferably, the shifting element by which the input and output shafts can be connected rotationally fixed to one another is provided axially between the input shaft and the output shaft positioned coaxially with it, so that the input shaft and the output shaft are in particular arranged axially next to one another. In principle, however, it would also be conceivable to provide the shifting element radially between the input shaft and the output shaft, and in that case one of the two shafts would have to be in the form of a hollow shaft, at least in part, which enclosed the other shaft.

In accordance with an embodiment of the invention at least one countershaft is provided with its axis parallel to the input and output shafts. In such a case, particularly preferably just one countershaft is positioned axis-parallel to the input and output shafts, although in the context of the invention a plurality of axis-parallel countershafts could also be provided.

In a further development of the above embodiment, between the input shaft and the at least one countershaft a spur gear stage is provided, which consists of a fixed gear arranged on the input shaft and a respective fixed gear that meshes with it positioned on the at least one countershaft. In that way a drive input constant is realized, by way of which the input shaft and the at least one countershaft are permanently coupled to one another with a constant transmission ratio.

According to an alternative or even supplementary further development of the above embodiment, between the output shaft and the at least one countershaft a plurality of spur gear stages are provided, each of them consisting of a loose or fixed gear arranged on the output shaft and, meshing with it, in each case a fixed or loose gear respectively positioned on the at least one countershaft. Thus, between the output shaft and the at least one countershaft a plurality of spur gear stages are provided, which are formed specifically by fixed and loose gear pairings. In individual spur gear stages the fixed gear concerned can be arranged on the output shaft or on the at least one countershaft, whereas the corresponding loose gear is provided on the at least one countershaft or on the output shaft. Then, with each of the spur gear stages a shifting element is associated, by means of which the loose gear concerned is connected fixed to the shaft concerned so that a power flow can be produced from the at least one countershaft to the output shaft with the corresponding gear ratio.

In the context of the invention, however, it is also conceivable that a constant ratio is established between the output shaft and the at least one countershaft, if on the output shaft and the at least one countershaft a fixed gear is provided in each case and the fixed gears mesh with one another. In this way a drive output constant is produced between the output shaft and the at least one countershaft. In that case a plurality of spur gear stages would have to be provided between the input shaft and the at least one countershaft, each consisting of a loose gear and a fixed gear with the loose gear positioned either on the input shaft or on the at least one countershaft and the corresponding fixed gear positioned either on the at least one countershaft or on the input shaft. In this case too a shifting element would then be associated with each spur gear stage.

In the context of the invention a fixed gear of a spur gear stage can be made either as a separate gearwheel positioned on the shaft concerned, or it may be formed integrally with the shaft. In the latter case, in the corresponding area the shaft is provided with teeth such that despite the absence of an independent gear the area is called a “fixed gear” in the context of the invention.

In accordance with a further design possibility of the invention, the shifting element by means of which the input and output shafts can be connected to one another in a rotationally fixed manner is combined with a further shifting element, forming a shifting element pair with which a common actuating element is associated. In such a case, by means of the actuating element, from a neutral position on the one hand the shifting element, and on the other hand the further shifting element can be actuated. Thus, in this case the two shifting elements are combined into a double shifting element in which, by means of a single actuating element, either the one or the other shifting element can be changed to its closed position. Advantageously the manufacturing cost can be reduced thereby since the number of actuating elements is smaller. Also preferred here, the other spur gear stages too, between the output shaft and the at least one countershaft or between the input shaft and the at least one countershaft, can be combined into shifting element pairs so that the number of actuating elements becomes substantially smaller.

In a further development of the invention the shifting elements are in the form of interlocking shifting elements, particularly locking synchronizers or claw-type shifting elements. In principle, however, in the context of the invention it would also be conceivable for the shifting elements to be frictional shifting elements such as disk shifting elements.

An agricultural machine transmission is in particular part of an agricultural machine group transmission made up of a plurality of individual transmissions. In this context an “agricultural machine group transmission” is understood to mean a transmission of group configuration specially provided for use in an agricultural or municipal utility vehicle. Particularly preferably, the agricultural machine transmission according to the invention is a range group of the agricultural machine group transmission, although alternatively the agricultural machine transmission can also be a main group of the group transmission. Apart from the agricultural machine transmission according to the invention, the agricultural machine group transmission can then also comprise a powershiftable splitter group and if necessary also a crawling gear group and a reversing group.

The invention is not limited to the combination of features indicated in the principal claim or the claims that depend on it. There are also possibilities for combining individual features with one another if they emerge from the claims, the description given below of a preferred embodiment of the invention, or directly from the drawings. References in the claims by the use of indexes are not intended to restrict the protective scope of the claims.

### BRIEF DESCRIPTION OF THE DRAWINGS

An advantageous embodiment of the invention, which will be explained below, is illustrated in the drawings, which show:

FIG. 1: A schematic view of a motor vehicle drive-train for an agricultural machine or a municipal utility vehicle; and

FIG. 2: A detailed view of part of a transmission of the motor vehicle drive-train shown in FIG. 1.

### DETAILED DESCRIPTION OF THE DRAWINGS

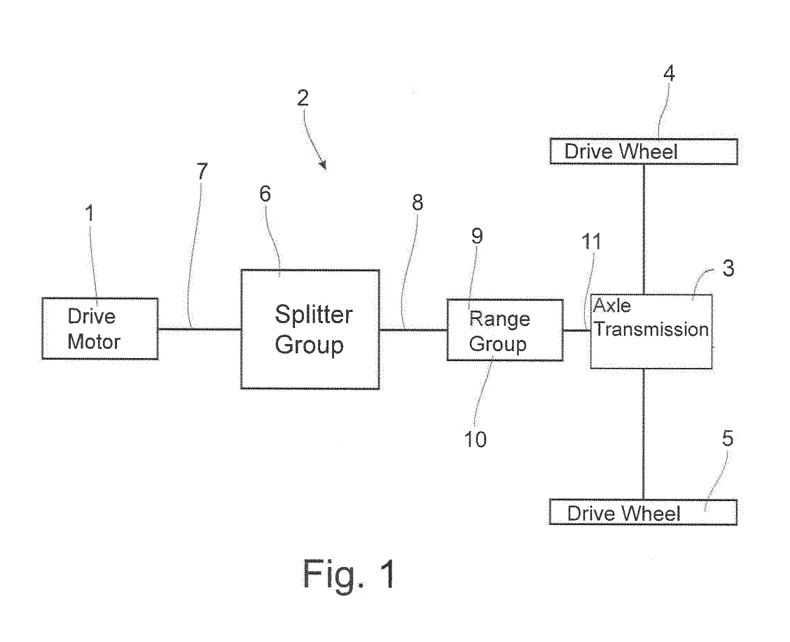

FIG. 1 shows a schematic view of a motor vehicle drive-train for an agricultural machine or a municipal utility vehicle, which can be a farm tractor, a system vehicle or even a self-driving harvester. As can be seen in FIG. 1, the motor vehicle drive-train comprises a drive motor 1 in the form of an internal combustion engine, which on its output side is connected to an agricultural machine group transmission 2. The agricultural machine group transmission 2 is configured in groups and transmits drive movement from the drive motor 1 to a downstream axle drive 3 by which the correspondingly geared-down drive movement is distributed to drive wheels 4 and 5 of an axle of the utility vehicle. However, the axle transmission 3 can also be integrated into the agricultural machine group transmission 2.

The agricultural machine group transmission 2 comprises a powershiftable splitter group 6 connected downstream from the drive motor 1 in the motor vehicle drive-train, and is thus connected to the drive motor 1 by way of a drive input shaft 7. On its output side the splitter group 6 is connected to an input shaft 8 of a downstream agricultural machine transmission 9, this being a range group 10 of the agricultural machine group transmission 2.

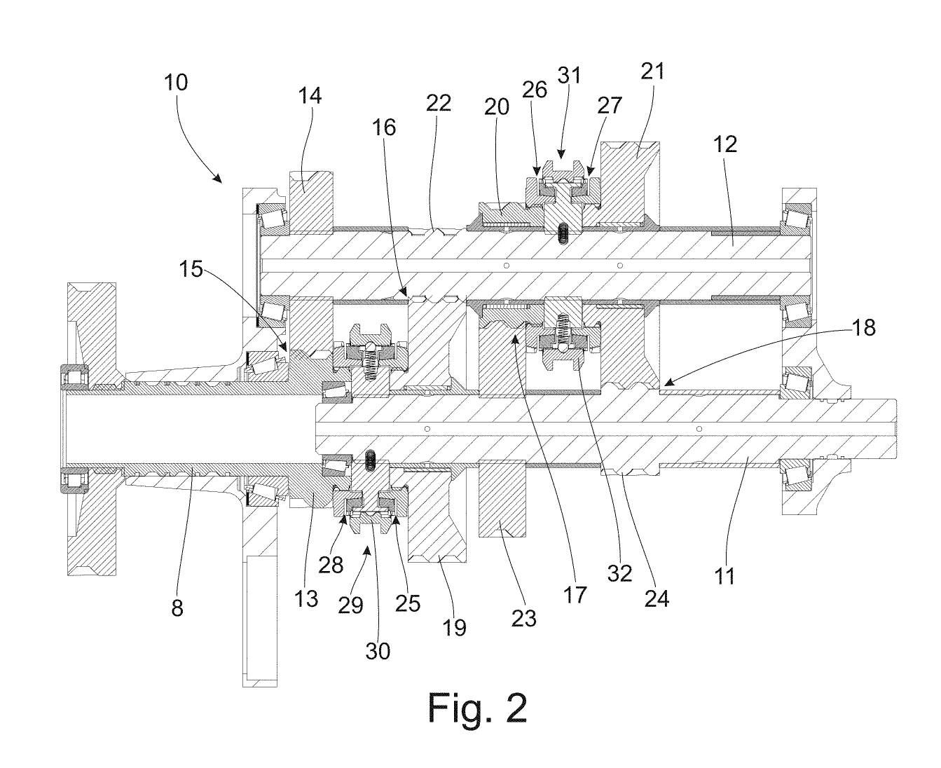

The range group 10 is then in turn connected on a drive output side to the axle drive 3 that follows it, by way of an output shaft 11. Specifically, the range group 10 is designed as a non-powershiftable synchronous transmission, part of which is shown in more detail in FIG. 2.

As can be seen in FIG. 2, the input shaft 8 and the output shaft 11 are arranged coaxially with one another and the range group 10 also comprises a countershaft 12 positioned with its axis parallel to the input shaft 8 and the output shaft 11. In the area of an axial end facing toward the output shaft 11 the input shaft 8 forms a fixed gear 13, which meshes with a fixed gear 14 fitted on the countershaft 12 in a rotationally fixed manner. Thus, together the two fixed gears 13 and 14 form a spur gear stage 15 which couples the input shaft 8 and the countershaft 12 permanently with one another in their rotational movements and therefore functions as a drive input constant.

Furthermore, between the countershaft 12 and the output shaft 11 a number of spur gear stages 16, 17 and 18 are provided, each consisting of a respective loose gear 19 or 20 or 21 and a respective fixed gear 22 or 23 or 24. To be specific, in the spur gear stage 16 the loose gear 19 is mounted to rotate on the output shaft 11 while the associated fixed gear 22 is formed by the countershaft 12. In contrast, the fixed gears 23 and 24 of the spur gear stages 17 and 18 are in each case positioned rotationally fixed on the output shaft 11, with the fixed gear 24 formed by the output shaft 11. The loose gears 20 and 21 of the spur gear stages 17 and 18 are then arranged and can rotate on the countershaft 12 in each case.

The loose gears 19, 20 and 21 can now each be fixed to the output shaft 11 or the countershaft 12 by a respectively associated shifting element 25 or 26 or 27, so that the output shaft 11 and the countershaft 12 are then coupled to one another by means of the respective spur gear stage 16 or 17 or 18 and ultimately a power flow passes from the input shaft 8 via the spur gear stage 15 to the countershaft 12 and from there, via the respective spur gear stage 16 or 17 or 18, to the output shaft 11. In that way a respective corresponding transmission ratio of the range group is engaged.

As a special feature, however, it is now possible in the range group 10 to connect the input shaft 8 directly and in a rotationally fixed manner to the output shaft 11, and in that way to produce a fixed drive path. For this purpose, axially between the input shaft 8 and the output shaft 11 a shifting element 28 is provided, which when actuated connects the input shaft 8 to the output shaft 11 in a rotationally fixed manner. In this way a transmission ratio of the range group 10 is also produced without the power flow having to pass by way of the countershaft 12.

In the present case the shifting elements 25 to 28 are each interlocking shifting elements designed specifically as locking synchronizers. As can also be seen in FIG. 2, the shifting element 25 and the shifting element 28 are combined as a shifting element pair 29 such that the shifting elements 25 and 28 are associated with a common actuating element 30 in the form of a sliding sleeve by means of which, starting from a neutral position, on the one hand the shifting element 25 and on the other hand the shifting element 28 can be actuated.

Likewise, the shifting elements 26 and 27 are combined as a shifting element pair 31 in which, by means of a common actuating element 32, starting from a neutral position on the one hand the shifting element 26 and on the other hand the shifting element 27 can be changed to a closed condition. The actuating element 32 is again in the form of a sliding sleeve.

By virtue of the design of an agricultural machine transmission according to the invention, a transmission ratio can be produced by compact means and with low manufacturing cost.

### INDEXES

1 Drive motor
2 Agricultural machine group transmission
3 Axle transmission
4 Drive wheel
5 Drive wheel
6 Splitter group
7 Drive input shaft
8 Input shaft
9 Agricultural machine transmission
10 Range group
11 Output shaft
12 Countershaft
13 Fixed gear
14 Fixed gear
15 Spur gear stage
16 Spur gear stage
17 Spur gear stage
18 Spur gear stage
19 Loose gear
20 Loose gear
21 Loose gear
22 Fixed gear
23 Fixed gear
24 Fixed gear
25 Shifting element
26 Shifting element
27 Shifting element
28 Shifting element
29 Shifting element pair
30 Actuating element
31 Shifting element pair
32 Actuating element

1-8. (canceled)

9. An agricultural machine transmission (9), for an agricultural machine group transmission (2) of either an agricultural or a municipal utility vehicle, comprising:
exactly one input shaft (8),
exactly one output shaft (11),
a plurality of shifting elements (25, 26, 27, 28), and by selective actuation of the plurality of shifting elements (25, 26, 27, 28) various transmission ratios between the input shaft (8) and the output shaft (11) being engagable, and
the input shaft (8) and the output shaft (11) being coaxial with one another and being directly connectable to one another in a rotationally fixed manner by actuating one (28) of the plurality of shifting elements.

10. The agricultural machine transmission (9) according to claim 9, wherein at least one countershaft (12) is arranged axially parallel to the input shaft (8) and the output shaft (11).

11. The agricultural machine transmission (9) according to claim 10, wherein a spur gear stage (15) is provided between the input shaft (8) and the at least one countershaft (12), and the spur gear stage (15) comprises a fixed wheel (13) arranged on the input shaft (8) and a corresponding fixed wheel (14), meshing therewith, and arranged on the at least one countershaft (12).

12. The agricultural machine transmission (9) according to claim 10, wherein a plurality of shifting elements (16, 17, 18) are provided between the output shaft (11) and the at least one countershaft (12), each of the plurality of shifting elements comprises either a loose wheel (19) or a fixed wheel (23, 24) arranged on the output shaft (11) and, meshing therewith, either a fixed wheel (22) or a loose wheel (20, 21), respectively, positioned on the at least one countershaft (12).

13. The agricultural machine transmission (9) according to claim 9, wherein the one (28) of the plurality of shifting elements, via which the input shaft (8) and the output shaft (11) are connectable rotationally fixed to one another, is combined with a further shifting element (25) to form a shifting element pair (29) with which a common actuating element (30) is associated such that, by actuating the common actuating element (30) from a neutral position, the one (28) of the plurality of shifting elements, on one hand, and the further shifting element (25), on the other hand, are actuatable.

14. The agricultural machine transmission (9) according to claim 9, wherein the plurality of shifting elements (25 to 28) are designed as interlocking shifting elements.

15. An agricultural machine group transmission (2) comprising:
an agricultural machine transmission (9) of either an agricultural or a municipal utility vehicle comprising:
exactly one input shaft (8),
exactly one output shaft (11),
a plurality of shifting elements (25, 26, 27, 28), and by selective actuation of the plurality of shifting elements (25, 26, 27, 28) various transmission ratios between the input shaft (8) and the output shaft (11) being engagable, and
the input shaft (8) and the output shaft (11) being coaxial with one another and being directly connectable to one another in a rotationally fixed manner by actuating one of the plurality of shifting elements (28).

16. The agricultural machine group transmission (2) according to claim 15, wherein the agricultural machine transmission (9) forms a range group (10).

17. An agricultural machine transmission (9) for an agricultural machine group transmission (2) of an agricultural or a municipal utility vehicle, the agricultural machine transmission (9) comprising:
only a single input shaft (8),
only a single output shaft (11),
a plurality of shifting elements (25, 26, 27, 28), and various transmission ratios, between the input shaft (8) and the output shaft (11), being engagable by selective actuation of plurality of shifting elements (25, 26, 27, 28), and
the input shaft (8) and the output shaft (11) being coaxially aligned with one another and being directly connected to one another, in a rotationally fixed manner, by actuating one (28) of the plurality of shifting elements.
